(19) United States
(12) Patent Application Publication
(10) Pub. No.: US 2009/0278816 A1
(43) Pub. Date: Nov. 12, 2009

(54) Systems and Methods For Resolving Multitouch Scenarios Using Software Filters

(75) Inventor: Keith John Colson, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holdings Limited, Auckland City (NZ)

(21) Appl. No.: 12/434,217

(22) Filed: May 1, 2009

(30) Foreign Application Priority Data
May 6, 2008 (NZ) 567965

(51) Int. Cl. G06F 3/042

(52) U.S. Cl. 345/175

(57) ABSTRACT

Software heuristics can be applied to determine which two points of a plurality of potential touch points are likely actual touch points based on a potential touch point's location relative to a predefined touch area and/or a characteristic of a hypothetical touch corresponding to the potential touch point. For instance, a software filter may determine if a potential touch point lies outside the touch area based on comparing coordinates of the potential touch point to boundaries of the predefined touch area. As another example, if the size of the hypothetical touch exceeds a threshold and is in a particular position (e.g., near an edge of the touch area), the potential touch point may be identified as a ghost touch point. As another example, a filter may evaluate whether a shape of the hypothetical touch exceeds a threshold for asymmetry; if so, the potential touch point may be identified as a ghost touch point.

### PRIORITY CLAIM

This application claims priority to New Zealand Provisional Patent Application No. 567,965, by Keith Colson, filed on May 6, 2008 and entitled OPTICAL TOUCHSCREEN RESOLVING MULTITOUCH WITH SOFTWARE FILTERS, which is hereby incorporated by reference herein in its entirety.

### TECHNICAL FIELD

The present subject matter pertains to touch display systems that allow a user to interact with one or more processing devices by touching on or near a surface.

### BACKGROUND

FIG. 1 illustrates an example of an optical/infrared-based touch detection system 100 that relies on detection of light traveling in optical paths that lie in one or more detection planes in an area 104 (“touch area” herein) above the touched surface. FIG. 2 features a perspective view of a portion of system 100. For example, optical imaging for touch screens can use a combination of line-scan or area image cameras, digital signal processing, front or back illumination, and algorithms to determine a point or area of touch. In this example, two light detectors 102A and 102B are positioned to image a bezel 106 (represented at 106A, 106B, and 106C) positioned along one or more edges of the touch screen area. Light detectors 102, which may be line scan or area cameras, are oriented to track the movement of any object close to the surface of the touch screen by detecting the interruption of light returned to the light detector's field of view 110, with the field of view having an optical center 112.

As shown in FIG. 2, in some systems, the light can be emitted across the surface of the touch screen by IR-LED emitters 114 aligned along the optical axis of the light detector to detect the existence or non existence of light reflected by a retro-reflective surface 107 along an edge of touch area 104 via light returned through a window 116. As shown in FIG. 1 at 108, the retroreflective surface along the edges of touch area 104 returns light in the direction from which it originated.

As an alternative, the light may be emitted by components along one or more edges of touch area 104 that direct light across the touch area and into light detectors 102 in the absence of interruption by an object.

As shown in the perspective view of FIG. 2, if an object 118 (a stylus in this example) is interrupting light in the detection plane, the object will cast a shadow 120 on the bezel (106A in this example) which is registered as a decrease in light retroreflected by surface 107. In this particular example, light detector 102A would register the location of shadow 120 to determine the direction of the shadow cast on border 106A, while light detector 102B would register a shadow cast on the retroreflective surface on bezel portion 106B or 106C in its field of view.

FIG. 3 illustrates the geometry involved in the location of a touch point T relative to touch area 104 of system 100. Based on the interruption in detected light, touch point T can be triangulated from the intersection of two lines 122 and 124. Lines 122 and 124 correspond to a ray trace from the center of a shadow imaged by light detectors 102A and 102B to the corresponding detector location in detector 102A and 102B, respectively. The borders 121 and 123 of one shadow are illustrated with respect to light detected by detector 102B.

The distance W between light detectors 102A and 102B is known, and angles α and β can be determined from lines 122 and 124. Coordinates (X,Y) for touch point T can be determined by the expressions tan α=Y/X and tan β=Y/(W−X).

However, as shown at FIG. 4, problems can arise if two points are simultaneously touched, with “simultaneously” referring to touches that happen within a given time interval during which interruptions in light are evaluated.

FIG. 4 shows two touch points TI and T2 and four resulting shadows 126, 128, 130, and 132 at the edges of touch area 104. Although the centerlines are not illustrated in this example, Point T1 can be triangulated from respective centerlines of shadows 126 and 128 as detected via light detectors 102A and 102B, respectively. Point T2 can be triangulated from centerlines of shadows 130 and 132 as detected via light detectors 102A and 102B, respectively. However, shadows 126 and 132 intersect at GI and shadows 128 and 130 intersect at G2, and the centerlines of the shadows can triangulate to corresponding “ghost” points, which are all potential touch position coordinates. However, with only two light detectors, these “ghost points” are indistinguishable from the “true” touch points at which light in the touch area is actually interrupted.

### SUMMARY

Objects and advantages of the present subject matter will be apparent to one of ordinary skill in the art upon careful review of the present disclosure and/or practice of one or more embodiments of the claimed subject matter.

In accordance with one or more aspects of the present subject matter, ghost points and true touch points can be distinguished from one another without resort to additional light detectors. In some embodiments, one or more software heuristics can be applied to determine whether one or more points of a plurality of potential touch points is/are likely an actual touch point or likely a ghost point. The software heuristics may be used alone or in conjunction with one or more other techniques for resolving multitouch scenarios.

For example, a software filter may be applied to determine if at least one potential touch point can be identified as likely a true touch point or as likely a ghost touch point based on at least one of: (i) the potential touch point's location relative to a predefined touch area or (ii) a characteristic of a hypothetical touch corresponding to the potential touch point.

For instance, a software filter may determine if a potential touch point lies outside the touch area based on comparing coordinates of the potential touch point to boundaries of the predefined touch area. If the potential touch point lies outside the predefined touch area, the potential touch point can be identified as a ghost touch point.

As another example, a software filter may determine a size of a hypothetical touch corresponding to the potential touch point. If the size of the hypothetical touch exceeds a threshold and is in a particular position (e.g., near an edge of the touch area), the potential touch point may be identified as a ghost touch point.

As another example, a software filter may evaluate a shape of the hypothetical touch corresponding to the potential touch point. If the shape of the hypothetical touch exceeds a threshold for asymmetry, the potential touch point may be identified as a ghost touch point. Additionally or alternatively, if the shape meets a symmetry threshold (such as a sufficiently high degree of symmetry to another hypothetical touch), the potential touch point may be identified as a true touch point.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures.

FIG. 1 is a block diagram illustrating an exemplary conventional touch screen system.

FIG. 2 is a perspective view of the system of FIG. 1.

FIG. 3 is a diagram illustrating the geometry involved in calculating touch points in a typical optical touch screen system.

FIG. 4 is a diagram illustrating the occurrence of “ghost points” when multiple simultaneous touches occur in an optical touch screen system.

FIG. 5 illustrates an exemplary touch screen system and a multitouch scenario that may be resolved using a software filter that identifies a potential touch point laying outside a valid touch area.

FIGS. 6A-6B illustrate a respective multitouch scenario that may be resolved using a software filter that evaluates the relative shape and/or symmetry of hypothetical touches at potential touch points.

FIGS. 6C-6D illustrate an example of evaluating symmetry of a hypothetical touch.

FIG. 7 illustrates a multitouch scenario that may be resolved using a software filter that evaluates the relative size of at least one hypothetical touch at a potential touch point.

FIG. 8 is a flowchart showing steps in an exemplary method for resolving multitouch scenarios using a routine that comprises software filters.

FIG. 9 is a diagram of a touch detection system comprising a computing device and a touch screen system.

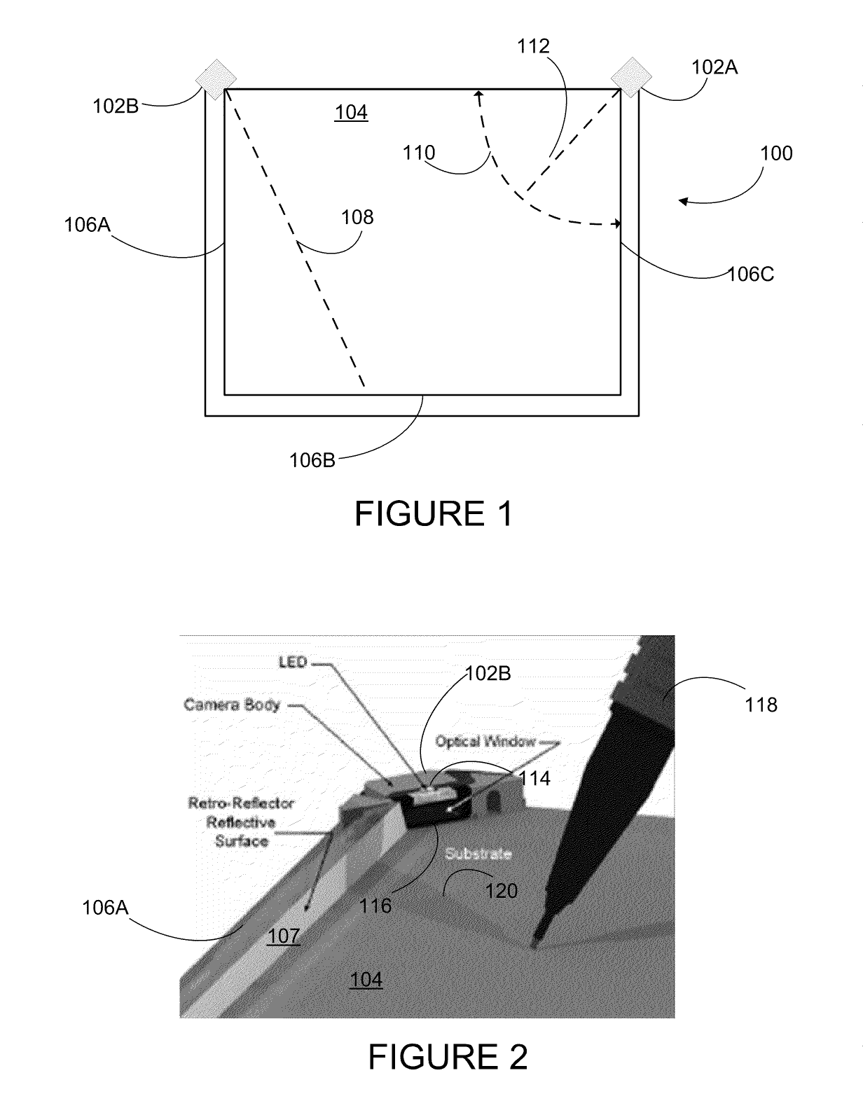

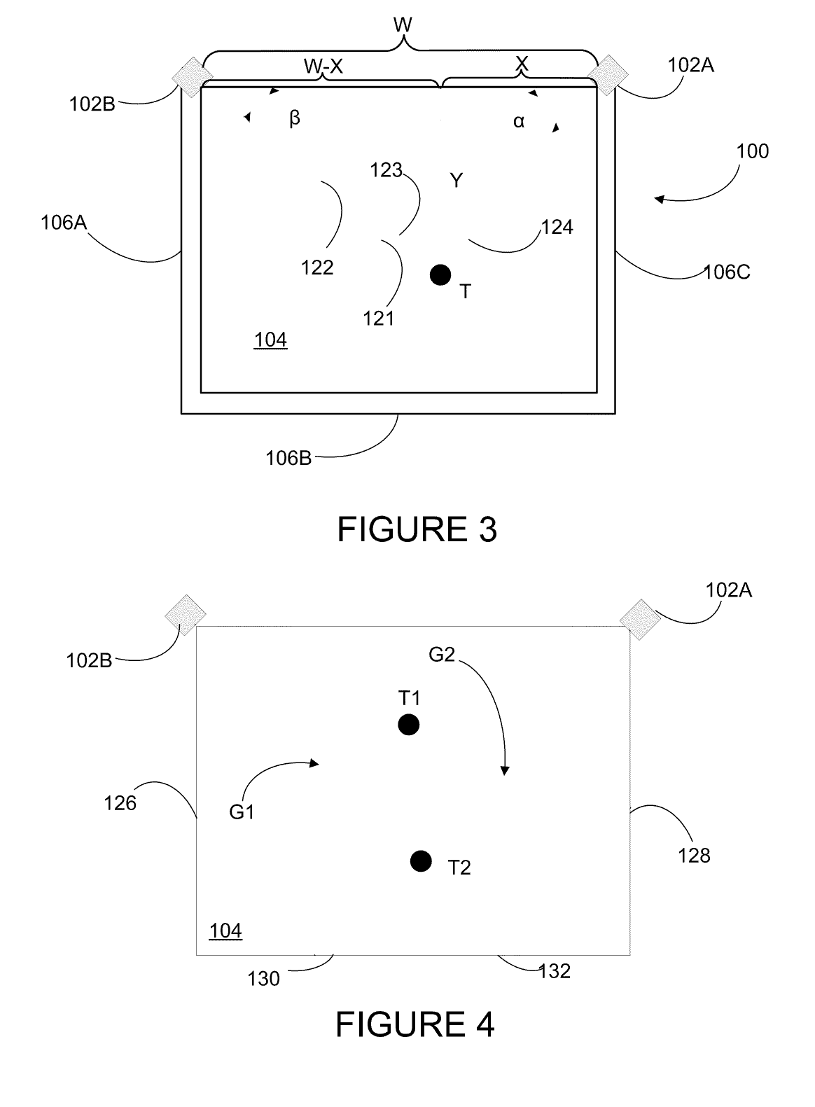

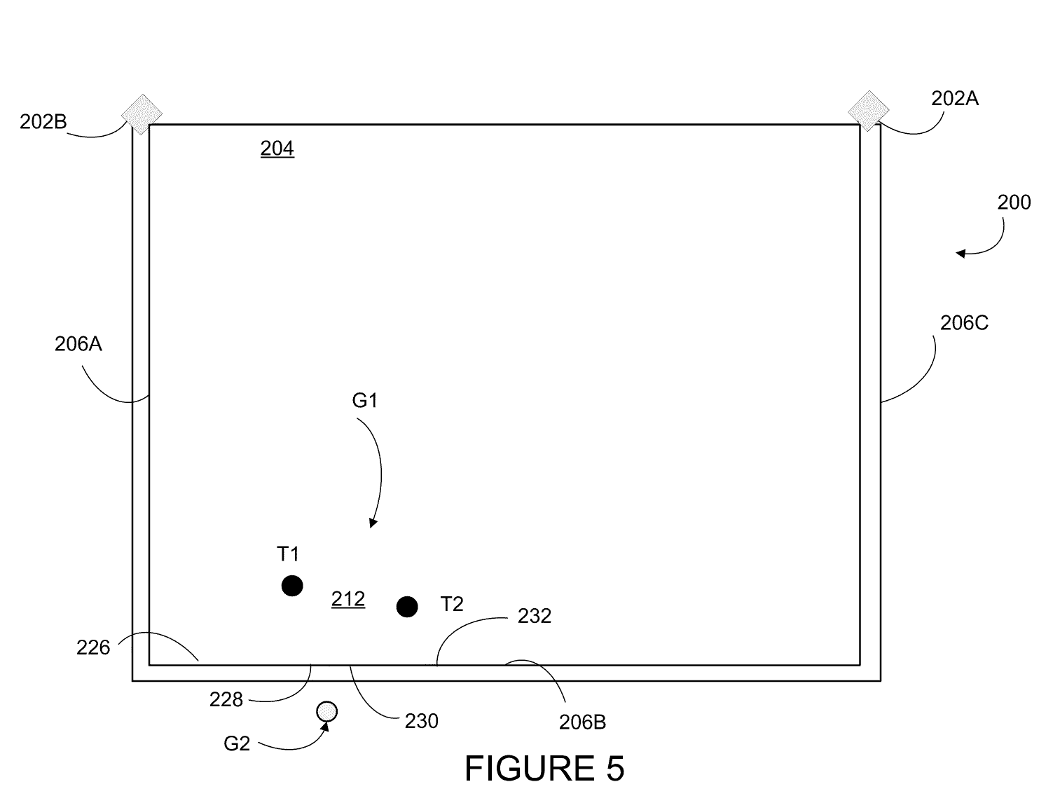

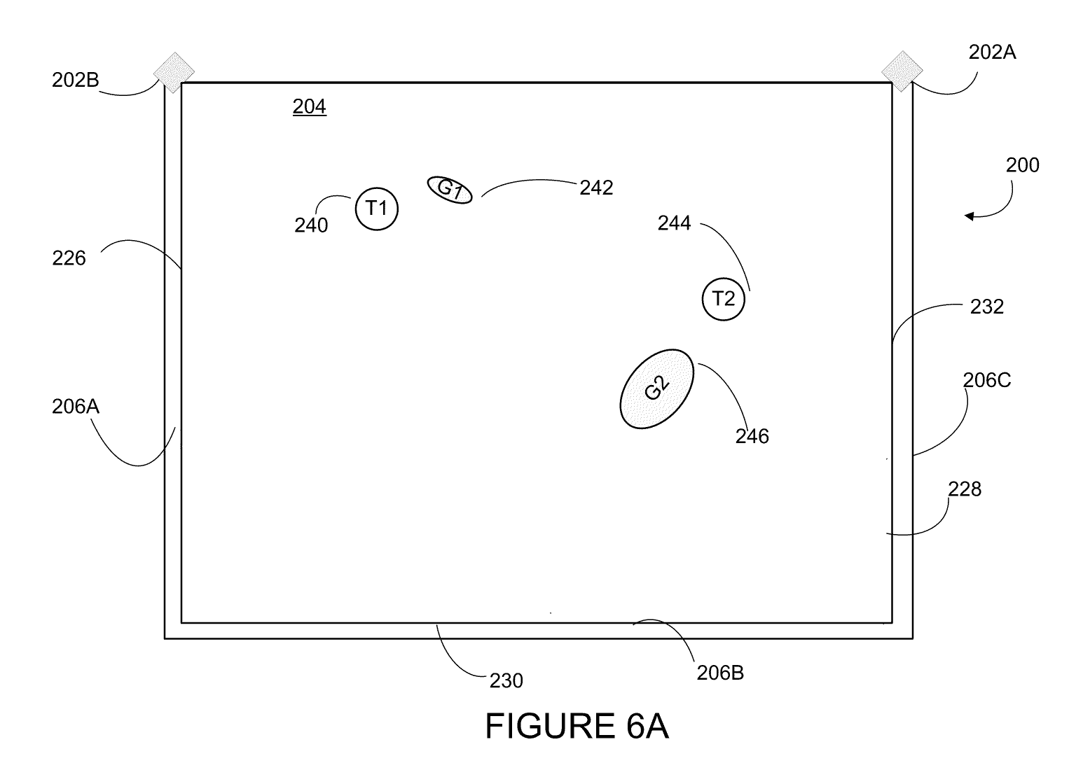

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made without departing from the scope or spirit of the disclosure and claims. For instance, features illustrated or described as part of one embodiment may be used on another embodiment to yield still further embodiments. Thus, it is intended that the present disclosure includes any modifications and variations as come within the scope of the appended claims and their equivalents.

Embodiments of the present subject matter can use one or more heuristics to resolve multitouch scenarios. For example, the heuristics may be implemented in software as part of a touch detection routine carried out by a processor accessing one or more computer readable media tangibly embodying program instructions. Additional detail on hardware implementations is provided later below. Multitouch Resolution Scenario 1: Potential Touch Point Outside Touchable Area

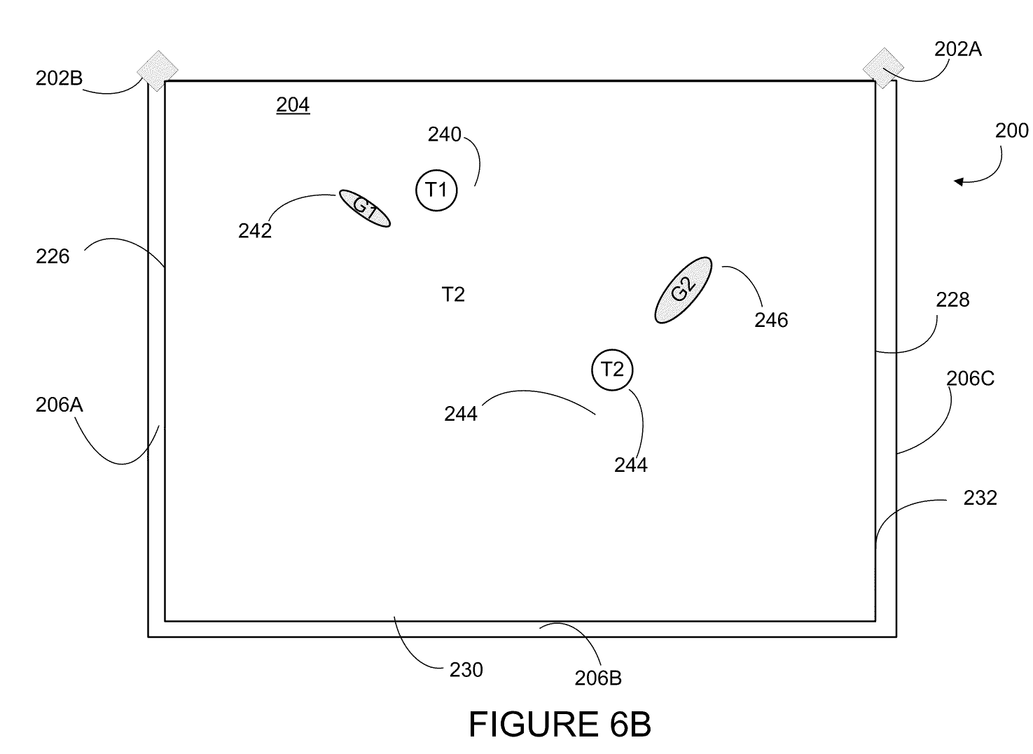

FIG. 5 illustrates an exemplary touch screen system 200 with hardware configured as in the examples above. Particularly, light detectors 202A and 202B are positioned to image a bezel 206 (represented at 206A, 206B, and 206C) positioned along one or more edges of touch screen area 204. As in the examples above, light detectors 202 may be line scan or area cameras, oriented to track the movement of any object close to the surface of the touch screen by detecting the interruption of light returned to the light detector's field of view. The detectors may track retroreflected light from an illumination system onboard the detectors and/or interruptions in ambient light.

In this example, two actual touch points T1 and T2 occur near the edge of touch area 204. The touch detection system identifies four shadows 226, 228, 230, and 232. The intersections of the shadows can resolve to four potential touch points, two of which correspond to actual touch points T1 and T2 and two of which correspond to ghost points G1 and G2.

In this scenario, one of the ghost points, G2, lies outside valid touch area for a touch point to occur-in this example, ghost point G2 actually lies below the bottom of touch area 204 past bezel 206. By a process of elimination, the touch detection system can determine that T1 and T2 correspond to the actual touch points.

In a scenario where ghost point G2 is not outside the touch area, a touch at either point T1 or G2 could cast shadow 228. Similarly, either point G2 or T2 could cast shadow 230. However, point G2 is outside the touch area in this scenario and therefore could not have cast shadows 228 and 230.

The potential touch points T1, T2, G1, and G2 form vertices of a quadrilateral 212. By determining that point G2 represents a vertex of quadrilateral 212 that is outside the touch area, the system can determine that the points corresponding to adjacent vertices of the quadrilateral (T1 and T2 in this example) are the actual touch points and the point at the opposite vertex (G1 in this example) is the ghost point.

For instance, if this relationship were not true with G2 outside the touch area, then the arrangement of shadows would not be the same-the true touches in this example are either the top and bottom touches or the left and right touches. Otherwise, there would be no shadow 228 or no shadow 230 and the touch points could be identified via triangulation from three shadows.

This example shows a scenario where one touch point lies outside touch area 204 at the bottom side of touch area 204. However, the same principle could be applied when triangulation yields a potential touch point that outside of the touch area as the left, right, or top side. As an example, cameras may be located at the top, left, or right side of touch area 204, rather than the bottom.

### Multitouch Resolution Scenario 2: Analysis of Touch Shape Symmetries

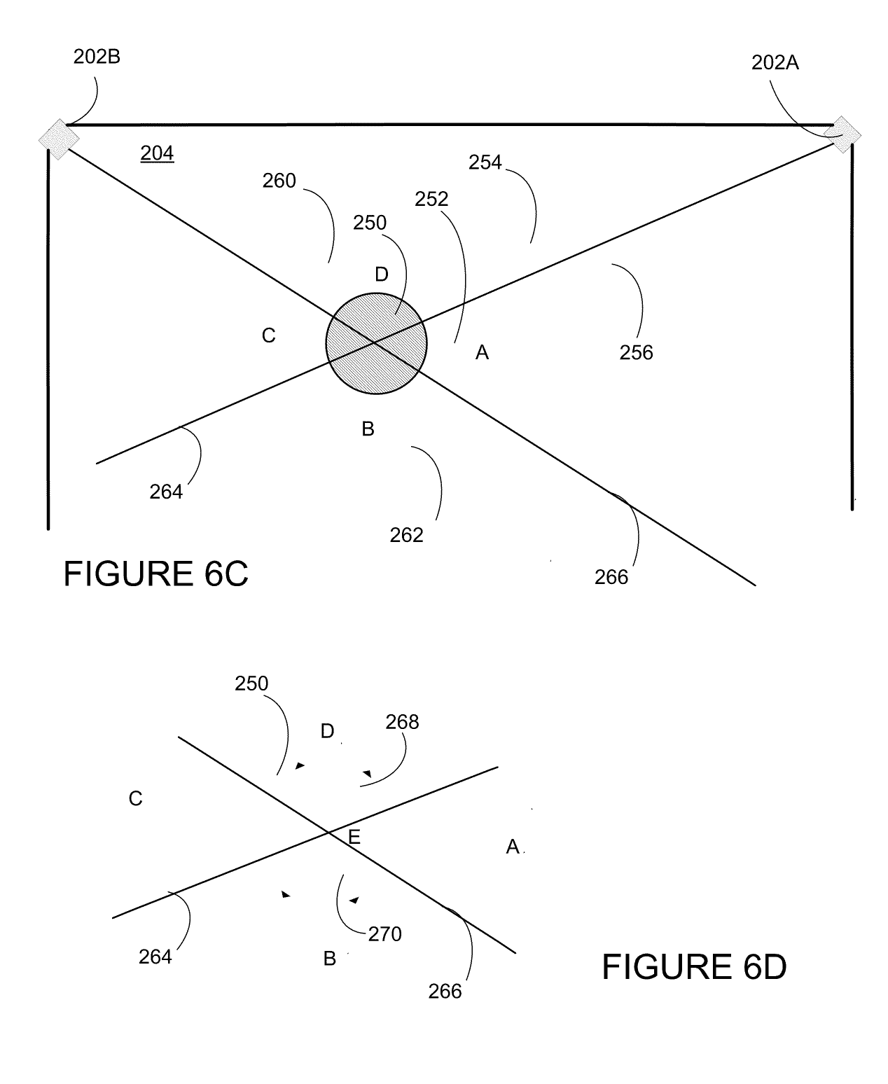

FIGS. 6A-6B illustrate exemplary touch screen system 200 with hardware configured as in the examples above, but illustrating another multitouch scenario. In this example, four potential touch points T1, T2, G1, and G2 are shown. As before, the actual touch points correspond to touches T1 and T2. Note that, although the true and ghost touches are labeled in these examples, this fact is not known to the touch detection system when the analysis begins. In this example, all potential touch points lie in the expected area (i.e. inside touch area 204), so filtering based on the scenario above cannot rule out the ghost points.

However, in this example, software filtering is used to analyze the relative symmetry or asymmetry of hypothetical shapes for the one or more of the four potential touches to identify one or both ghost touches.

Particularly, each potential touch point lies within an area 240, 242, 244, and 246 defined by the edges of two shadows. In this example, area 240 is defined by the edges of shadow 226 and the edges of shadow 228; area 242 is defined by the edges of shadow 226 and 232; area 244 is defined by the edges of shadows 230 and 232; and area 246 is defined by the edges of shadows 228 and 230.

Although triangulation of touch points T1, T2, G1, and G2 can be based on the intersection of centerlines of shadows 226-232, a touch detection routine can be configured to trace the shadow boundaries and determine the relative size and shape of areas 240, 242, 244, and 246. By assuming that real touches should be approximately symmetrical, one or more potential touch points can be assumed to be real touch points based on evaluating the symmetry of the hypothetical touch.

In the example of FIG. 6A, hypothetical touches interrupting the path of light in the touch area are shown by ellipses at points T1, T2, G1, and G2. For instance, shadow 226 can be assumed to have been caused by an object in area 240 or in area 242; shadow 228 can be assumed to have been caused by an object in area 240 or 246, and so on. The actual shadows may be cast by non-elliptical or non-circular objects, of course.

Note that if an object were at both potential areas that could cast a given shadow (i.e., an interruption as due to a touch at both area 240 and 242), then only three shadows (i.e., 226, 232, and 228) would be cast.

As can be seen, in order to have caused shadows that define areas 242 and 246, respectively, the hypothetical touches are “squashed” in different ways due to differences in the shape/orientation of areas 242 and 246. On the other hand, circles can be defined within areas 240 and 244 to achieve a shape tangent to the edges of those areas. In some cases, ellipses may result in areas 240 and 244, but with generally the same orientation/shape.

Based on the symmetry of one or more of the hypothetical touches, the touch detection system can determine which touch points are real touch points and which touch points are ghost points. In this example, G1 and G2 are relatively asymmetrical as compared to shapes of the hypothetical touches T1 and T2. Thus, the touch detection system can determine that points T1 and T2 are the true touches.

In FIG. 6A, the left and right touch points were the “true” touch points. Turning to FIG. 6B, an example is shown where the top and bottom touch points (T1, T2) are the true touch points. As before, four shapes for T1, G1, T2, and G2 are illustrated corresponding to the boundaries of respective areas 240, 242, 244, and 246. Again, in order for the hypothetical touches to have caused shadows resulting in their respective areas, hypothetical touches at G1 and G2 must be “squashed” as compared to hypothetical touches for T1 and T2. Thus, it can be concluded that T1 and T2 are the true touch points.

In some embodiments, only a single point need be identified as a ghost point. For example, once G1 or G2 is known to be a ghost point, the remaining ghost point can be identified through a process of elimination. Namely, if G2 is known to be a ghost point, it follows that shadow 230 must be due to T2 being a true touch point and shadow 228 must be due to T1 being a true touch point. However, some embodiments evaluate the symmetry/asymmetry of all points to affirmatively identify multiple ghost points or true touch points.

FIGS. 6C-6D illustrate an example of evaluating symmetry in closer detail. FIG. 6C shows a closer view of a hypothetical touch 250. As illustrated, hypothetical touch 250 is defined by a first shadow having edges 254 and 256 as detected using a sensor of detector 202A and a second shadow having edges 260 and 262 as detected using detector 202B. The first shadow has a center line 264 and the second shadow has a center line 266, which intersect at a point E (illustrated in FIG. 6D). Hypothetical touch 250 lies in an area 252 defined by quadrilateral ABCD, shown in a closer view in FIG. 6D.

In some embodiments, symmetry can be measured using tangent lines 268 and 270. Tangent line 268 can be drawn from intersection point E at which center lines 264 and 266 intersect so as to be tangent to the camera focal point of detector 202B and/or at a 90 degree angle to center line 266. Tangent line 270 is also drawn from intersection point E, but to be tangent to the cameral focal point of detector 202A and/or at a 90 degree angle to center line 264.

Both tangent lines are drawn to pass through intersection point E and encompass the whole shadow of hypothetical touch 250. That is, tangent line 268 is drawn to reach line AD and line BC, while tangent line 270 is drawn to reach line CD and AB.

The ratio of tangent line 268 to tangent line 270 can be used to determine a symmetry number. If the lines are equal, the symmetry number will equal 1 and indicate that hypothetical touch 250 is symmetrical. As hypothetical touch 250 becomes “squashed,” the symmetry number will diverge from 1.

A touch detection routine can be configured to perform suitable calculations to determine tangent line lengths and a symmetry number for at least one hypothetical touch. The touch point of the hypothetical touch can be determined to be a real or ghost touch point based on a threshold value for its symmetry number in some embodiments. In some embodiments, the symmetry number of the hypothetical touch can be compared to at least one other hypothetical touch to determine a plurality of potential touch points having hypothetical touches with the closest symmetries to one another.

The example above depicted evaluation of a touch point's symmetry based on tangent lines in the context of a two-camera detection system. However, the technique could be applied in other contexts. For example, more than two cameras could be used, with the hypothetical touch point laying in a polygon defined by the edges of the intersecting shadows.

The above technique was also discussed in the context of a scenario with two real touches. However, the evaluation of symmetry could be used in resolving multitouch scenarios with more than two true touches and/or more than two ghost points.

### Multitouch Resolution Scenario 3: Relatively Large Potential Touch Point

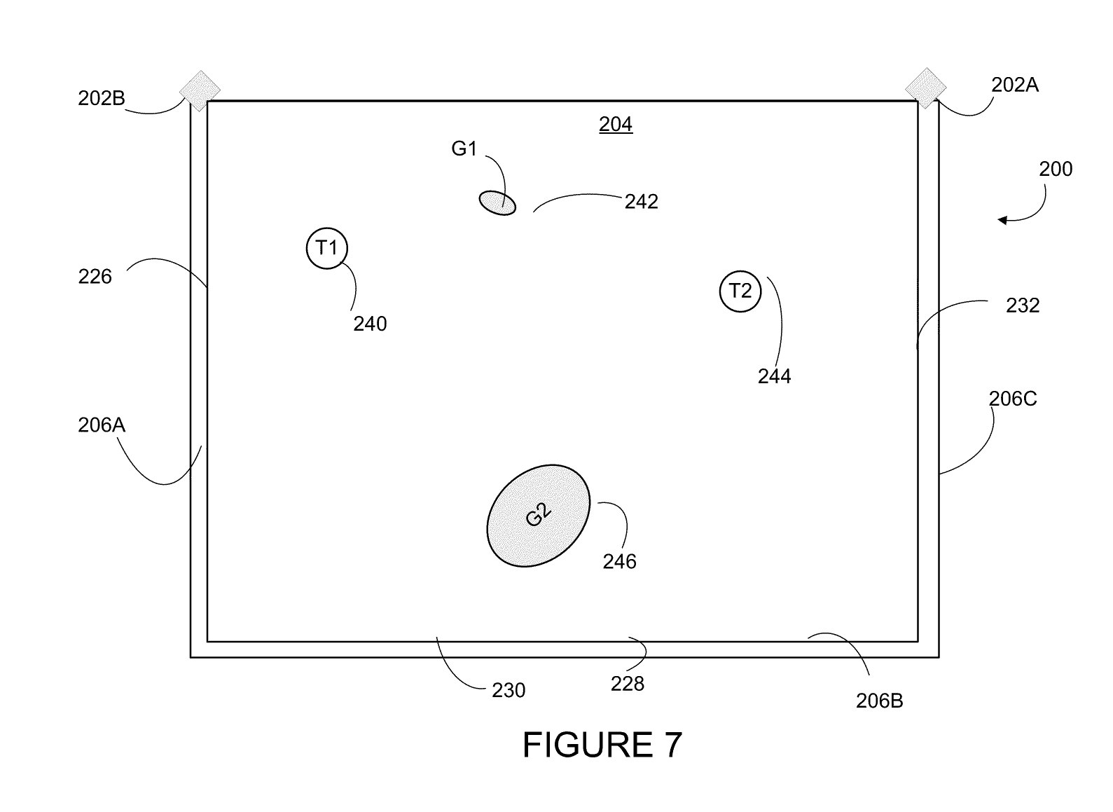

FIG. 7 illustrates exemplary touch screen system 200 with hardware configured as in the examples above, but illustrating another multitouch scenario. In this example, four potential touch points T1, T2, G1, and G2 are shown. As before, the actual touch points correspond to touches T1 and T2, but this is not known to the touch system initially.

As noted above, in some embodiments a touch detection routine can determine hypothetical shapes for each potential touch point by determining what shapes positioned at areas 240, 242, 244, and 246 could have cast the combination of detected shadows. As shown in FIG. 7, the hypothetical shape corresponding to potential touch point G2 (a ghost point) is much larger than the other hypothetical shapes corresponding to potential touch points T1, T2, and G2. Based on evaluating the relative sizes of the respective shapes, the touch detection routine can determine that potential touch point G2 likely corresponds to a ghost point.

With that data known, it follows that potential touch point T1 must be a true touch point, since shadow 228 is cast. Additionally, since point G2 is not a real touch point, it follows that potential touch point T2 must be a true touch point since shadow 230 was cast.

The hypothetical touch point sizes may be evaluated in any suitable way. In some embodiments, at least one tangent line for each hypothetical touch is determined as noted above for evaluating symmetry. The tangent sizes for multiple hypothetical touches can be compared to one another and then thresholded. For example, in some embodiments, if the bottom touch is about 20% larger than the side touches, the filter is triggered and the bottom touch is deemed the ghost touch.

The same principles could be applied with other camera/sensor positions, of course. For example, if sensors were positioned at the bottom corners of the touch area, the filter may be triggered if the top touch were 20% larger than the side touches. As another example, if sensors were positioned at a top and bottom corner on the same side, a side touch 20% larger than the top and bottom touch could trigger the filter.

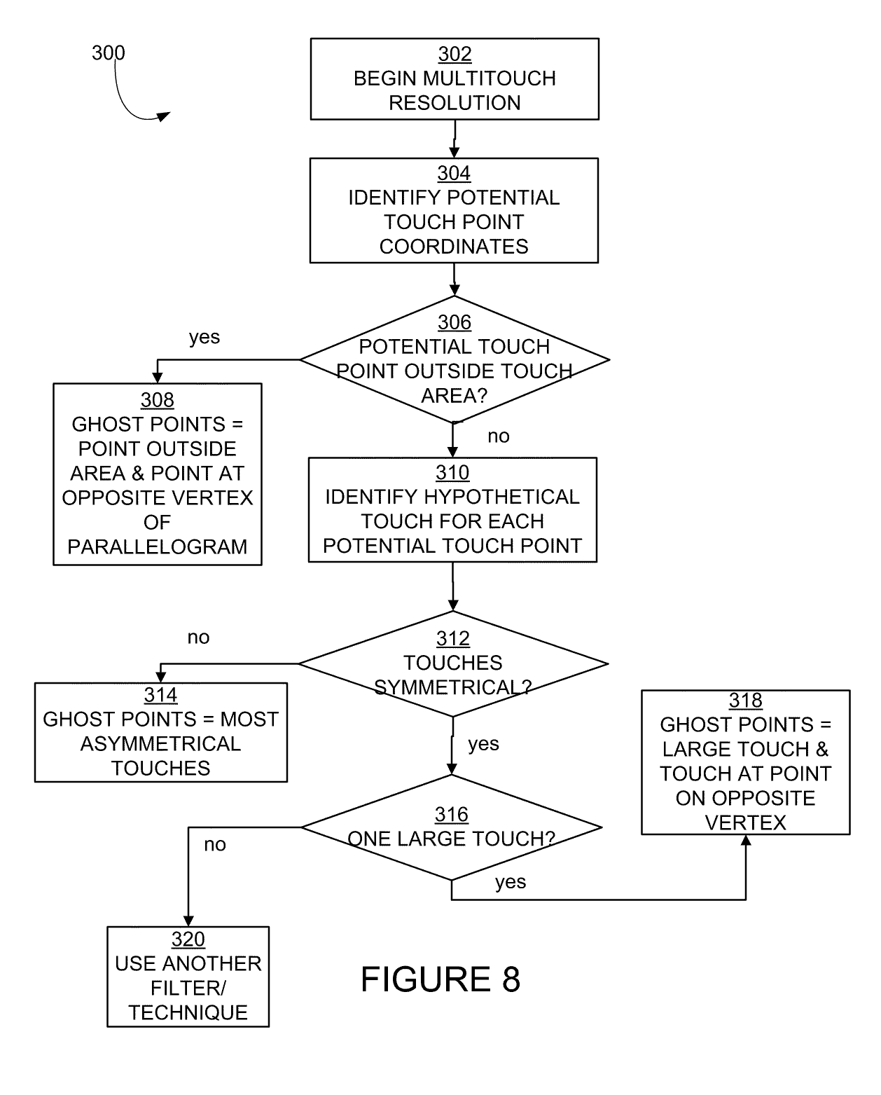

FIG. 8 is a flowchart showing steps of an exemplary method 300 for resolving multitouch scenarios via software filters. Method 300 may be a sub-process in a larger routine for touch detection executed by a processor in a touch-enabled device.

Block 302 represents beginning the multitouch resolution process. For example, a conventional touch detection method may be modified to call an embodiment of method 300 to handle a multitouch scenario triggered by a detector identifying multiple simultaneous shadows or may be called in response to a triangulation calculation result identifying a plurality of potential touch points for a given sample interval. Once the “actual” points have been identified, the coordinates as determined from triangulation or other technique(s) can be used in any suitable manner. As another example, method 300 may be called to double-check results of another technique used to resolve a multitouch scenario.

In this example, at block 304, the method identifies four potential touch points. For example, if method 300 represents steps of a routine called by another portion of a touch detection routine, the four potential touch point coordinates may already have been triangulated.

If method 300 represents steps of a main touch detection routine, block 304 may represent triangulating up to four potential touch points. If four potential touch points are not identified—i.e., if there is only a single touch or two touches are along the same line, then block 304 may further include an exit since the single touch or two touches along the line will not require multitouch resolution—ordinary triangulation can be used.

Assuming four potential touch points have been identified, the method moves to block 306 which checks whether one potential touch point is outside the touch area. For instance, one touch point may lie outside the touch area as in the example of FIG. 5. If that is the case, the method branches to block 308, where it is determined that the ghost points include the potential touch point outside the touch area and the touch point at the opposite vertex of the quadrilateral formed by the four potential touch points, while the real touch points are the points at the vertices adjacent the touch point that is outside the touch area. Of course, if two of the four potential touch points lie outside the touch area, then the two potential touch points inside the touch area must be the real touch points.

If, at block 306, all potential touch points are in the touch area, then the method moves on to attempt to identify another suitable filter. In this example, the method moves to block 310 to identify a hypothetical touch corresponding to each potential touch point, if this has not been done already at triangulation. For example, as was noted above, the edges of the four shadows may be traced to identify an area corresponding to each touch point and hypothetical touch can be defined for each area that is representative of a shape that could cast the detected shadows if positioned at the respective potential touch point.

At block 312, one or more of the hypothetical touches can be evaluated in terms of symmetry. For instance, a symmetry number can be determined as noted above and/or another suitable technique can be used. If one or more of the hypothetical touches is not symmetric—e.g., the touch is “squashed” as in the examples of FIGS. 6A and 6B, the most asymmetric touch may be considered a ghost touch at block 314. For instance, the symmetry number may be thresholded and/or compared to symmetry numbers for the other hypothetical touches.

The remaining ghost touch may be identified through a process of elimination or may be identified as the next most asymmetric shape. Additionally or alternatively, block 314 can represent identifying the most symmetric pair of hypothetical shapes, with the corresponding potential touch points of the most symmetric shapes identified as true touch points.

If the analysis of symmetry or other shape characteristics at block 312 does not resolve the multitouch scenario, the method moves on to block 316. At block 316, the method checks to see whether one of the hypothetical touch points comprises a large touch point as in the example of FIG. 7. For example, the size of the large hypothetical touch point may be evaluated against a size threshold. If the large hypothetical touch point is farthest from the sensors detecting interruptions in light in the touch area, the large hypothetical touch point can be considered a ghost point as shown at block 318. The potential touch point opposite the ghost point can also be considered a ghost point, with the remaining two potential touch points comprising the true touch points.

In this example, method 300 terminates at block 308, 314, or 318, respectively if a filter is successful in resolving the multitouch scenarios. In some embodiments, two or more filters can be used to double-check results as desired. Although the methods were presented in conjunction with one another in the example above, an embodiment could use any one of the methods alone.

If no filters are able to successfully resolve the multitouch scenario, the touch detection routine moves to block 320, which represents using another filter or technique to attempt to resolve the multitouch scenario. As another example, the routine may report an error.

Once the true touch points are identified, the touch detection routine can provide coordinates (and/or shapes) to additional components of the touchscreen system. For example, user interface or other components that handle input provided via a touchscreen can be configured to support multitouch gestures specified by reference to two simultaneous touch points.

In some embodiments, the “final” determination of true/ghost points may be left to other components or routines. For example, one or more software filters configured in accordance with the present subject matter can be used to provide data indicating that one or more potential touch points is likely a ghost touch point or likely a true touch point for use by other components in resolving the multitouch scenario. The data may include an indication that one or more touch point is likely a true or ghost touch point, or may simply identify the one or more true/ghost touch points.

Although the examples herein referred to “touch” points, the same principles could be applied in another context, such as when a shadow is due to a “hover” with no actual contact with a touch surface at one or more of the points.

Several examples above were presented in the context of a two-camera detection system and resolving multitouch scenarios featuring four potential touches including two true touches and two ghost touches. The techniques disclosed herein could be applied in other contexts. For example, more than two cameras could be used and/or the techniques could be used in the course of resolving multitouch scenarios with more than four potential touch points. Additionally, the techniques may be applicable regardless of whether the potential touch points include more or fewer than two true touches and/or more or fewer than two ghost points.

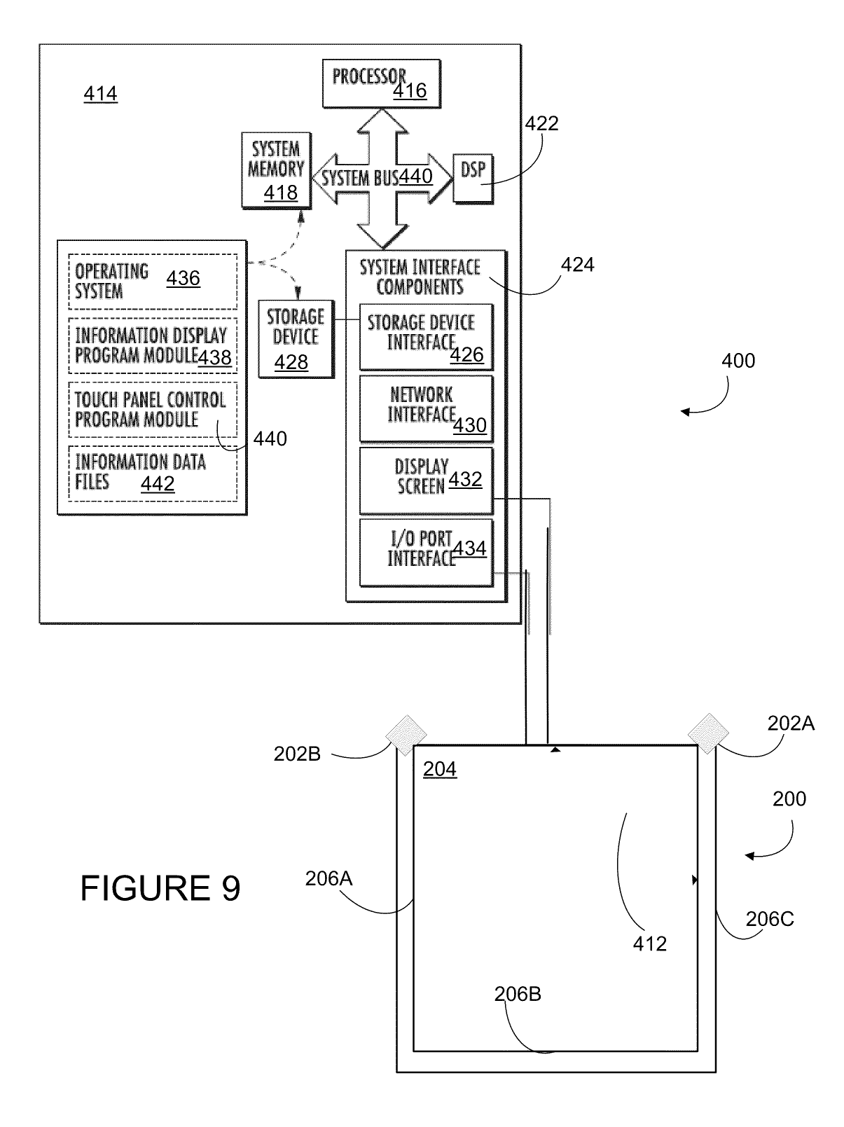

FIG. 9 is a block diagram illustrating an exemplary touch detection system 400 comprising a touch screen system 200 interfaced to an exemplary computing device 414. Computing device 414 may be functionally coupled to touch screen system 200 by hardwire and/or wireless connections. Computing device 414 may be any suitable computing device, including, but not limited to a processor-driven device such as a personal computer, a laptop computer, a handheld computer, a personal digital assistant (PDA), a digital and/or cellular telephone, a pager, a video game device, etc. These and other types of processor-driven devices will be apparent to those of skill in the art. As used in this discussion, the term “processor” can refer to any type of programmable logic device, including a microprocessor or any other type of similar device.

Computing device 414 may include, for example, a processor 416, a system memory 418, and various system interface components 424. Processor 416, system memory 418, a digital signal processing (DSP) unit 422 and system interface components 424 may be functionally connected via a system bus 440. The system interface components 424 may enable processor 416 to communicate with peripheral devices. For example, a storage device interface 426 can provide an interface between the processor 416 and a storage device 428 (removable and/or non-removable), such as a disk drive. A network interface 430 may also be provided as an interface between the processor 416 and a network communications device (not shown), so that the computing device 414 can be connected to a network.

A display screen interface 432 can provide an interface between the processor 416 and display device of the touch screen system 401. For instance, interface 416 may provide data in a suitable format for rendering by the display device over a DVI, VGA, or other suitable connection to a display positioned relative to touch detection system 401 so that touch area 404 corresponds to some or all of the display area. The display device may comprise a CRT, LCD, LED, or other suitable computer display, or may comprise a television, for example.

The screen may be is bounded by edges 406A, 406B, and 406C. A touch surface may correspond to the outer surface of the display or may correspond to the outer surface of a protective material positioned on the display. The touch surface may correspond to an area upon which the displayed image is projected from above or below the touch surface in some embodiments.

One or more input/output (“I/O”) port interfaces 434 may be provided as an interface between the processor 416 and various input and/or output devices. For example, the detection systems and illumination systems of touch detection system 401 may be connected to the computing device 414 and may provide input signals representing patterns of light detected by the detectors to the processor 416 via an input port interface 434. Similarly, the illumination systems and other components may be connected to the computing device 414 and may receive output signals from the processor 416 via an output port interface 434.

A number of program modules may be stored in the system memory 418, any other computer-readable media associated with the storage device 428 (e.g., a hard disk drive), and/or any other data source accessible by computing device 414.

The program modules may include an operating system 436. The program modules may also include an information display program module 438 comprising computer-executable instructions for displaying images or other information on a display screen. Other aspects of the exemplary embodiments of the invention may be embodied in a touch screen control program module 440 for controlling the illumination system(s), detector assemblies, and/or for calculating touch locations, and discerning interaction states relative to the touch screen based on signals received from the detectors.

In some embodiments, a DSP unit is included for performing some or all of the functionality ascribed to the Touch Panel Control program module 440. As is known in the art, a DSP unit 422 may be configured to perform many types of calculations including filtering, data sampling, and triangulation and other calculations and to control the modulation and/or other characteristics of the illumination systems. The DSP unit 422 may include a series of scanning imagers, digital filters, and comparators implemented in software. The DSP unit 422 may therefore be programmed for calculating touch locations and discerning other interaction characteristics as known in the art.

The processor 416, which may be controlled by the operating system 436, can be configured to execute the computer-executable instructions of the various program modules. Methods in accordance with one or more aspects of the present subject matter may be carried out due to execution of such instructions. As an example, operating system 436 may use a driver or interface with an application that reports single touch or multitouch coordinates. Furthermore, the images or other information displayed by the information display program module 438 may be stored in one or more information data files 442, which may be stored on any computer readable medium associated with or accessible by the computing device 414.

When a user touches on or near the touch screen, a variation will occur in the intensity of the energy beams that are moving across the surface of the touch screen in one or more detection planes. The detectors are configured to detect the intensity of the energy beams reflected or otherwise scattered across the surface of the touch screen and should be sensitive enough to detect variations in such intensity. Information signals produced by the detector assemblies and/or other components of the touch screen display system may be used by the computing device 414 to determine the location of the touch relative to the touch area 404. Computing device 414 may also determine the appropriate response to a touch on or near the screen.

In accordance with some implementations, data from the detection system may be periodically processed by the computing device 414 to monitor the typical intensity level of the energy beams directed along the detection plane(s) when no touch is present. This allows the system to account for, and thereby reduce the effects of, changes in ambient light levels and other ambient conditions. The computing device 414 may optionally increase or decrease the intensity of the energy beams emitted by the primary and/or secondary illumination systems as needed. Subsequently, if a variation in the intensity of the energy beams is detected by the detection systems, computing device 414 can process this information to determine that a touch has occurred on or near the touch screen.

The location of a touch relative to the touch screen may be determined, for example, by processing information received from each detection system and performing one or more well-known triangulation calculations plus resolving multitouch scenarios as noted above. The location of the area of decreased energy beam intensity relative to each detection system can be determined in relation to the coordinates of one or more pixels, or virtual pixels, of the display screen. The location of the area of increased or decreased energy beam intensity relative to each detector may then be triangulated, based on the geometry between the detection systems to determine the actual location of the touch relative to the touch screen. Any such calculations to determine touch location can include algorithms to compensate for discrepancies (e.g., lens distortions, ambient conditions, damage to or impediments on the touch screen or other touched surface, etc.) as applicable.

### General Considerations

Examples above referred to various illumination sources and it should be understood that any suitable radiation source can be used. For instance, light emitting diodes (LEDs) may be used to generate infrared (IR) radiation that is directed over one or more optical paths in the detection plane. However, other portions of the EM spectrum or even other types of energy may be used as applicable with appropriate sources and detection systems.

Several of the above examples were presented in the context of a touch-enabled display. However, it will be understood that the principles disclosed herein could be applied even in the absence of a display screen when the position of an object relative to an area is to be tracked. For example, the touch area may feature a static image or no image at all.

The various systems discussed herein are not limited to any particular hardware architecture or configuration. As was noted above, a computing device can include any suitable arrangement of components that provide a result conditioned on one or more inputs. Suitable computing devices include multipurpose microprocessor-based computer systems accessing stored software, but also application-specific integrated circuits and other programmable logic, and combinations thereof. Any suitable programming, scripting, or other type of language or combinations of languages may be used to implement the teachings contained herein in software.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Any suitable computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art

What is claimed:

1. A method of identifying a likely true touch point or ghost touch point from a plurality of touch points in a touch detection system, the method comprising:
accessing data identifying a plurality of potential touch points; and
applying a software filter to determine if at least one potential touch point can be identified as likely a true touch point or a ghost touch point based on at least one of: (i) the potential touch point's location relative to a predefined touch area or (ii) a characteristic of a hypothetical touch corresponding to the potential touch point.

2. The method set forth in claim 1, wherein applying a software filter comprises:
determining if the potential touch point lies outside the predefined touch area based on comparing coordinates of the potential touch point to boundaries of the predefined touch area;
if the potential touch point lies outside the predefined touch area, identifying the potential touch point as likely a ghost touch point.

3. The method set forth in claim 1, wherein applying a software filter comprises:
determining a size of the hypothetical touch corresponding to the potential touch point; and
if the size of the hypothetical touch exceeds a threshold, identifying the potential touch point as likely a ghost touch point.

4. The method set forth in claim 3, wherein the potential touch point is identified as likely a ghost touch point if the size of the hypothetical touch exceeds a threshold and the potential touch point is positioned nearest to an edge of the predefined touch area.

5. The method set forth in claim 1, wherein applying a software filter comprises:
evaluating a measure of symmetry of the hypothetical touch corresponding to the potential touch point; and
identifying the potential touch point as likely a ghost touch point based on a threshold for symmetry or asymmetry.

6. The method set forth in claim 5, wherein the measure of symmetry is determined by calculating a first tangent line tangent to the focal point of a first detector and calculating a second tangent line tangent to the focal point of a second detector; and calculating a ratio based on the length of the first and second tangent lines.

7. The method set forth in claim 1, wherein applying a software filter comprises:
determining a shape of the hypothetical touch corresponding to each of the potential touch points;
identifying two hypothetical touches that are most symmetrical; and
identifying the potential touch points corresponding to the two hypothetical touches that are most symmetrical as true touch points.

8. The method set forth in claim 1, further comprising:
directing light across the predefined touch area;
identifying four shadows; and
triangulating coordinates for four potential touch points from the intersections of the four shadows.

9. The method set forth in claim 8, further comprising:
determining a hypothetical touch corresponding to each potential touch point based on the shape of a respective area containing the touch point, the area defined by the edges of two intersecting shadows.

10. A touch detection system, comprising:
a retroreflector positioned along at least one edge of a touch surface in a touch area;
a light detection system positioned to image the retroreflector; and
a computing system interfaced with the light detection system and the illumination system, the computing system configured to:
determine a plurality of points at which light in the touch area has been interrupted based on identifying shadows from the image of the retroreflector, and
apply a software filter to determine if at least one potential touch point can be identified as likely a true touch point or a ghost touch point based on at least one of: (i) the potential touch point's location relative to the touch area or (ii) a characteristic of a hypothetical touch corresponding to the potential touch point.

11. The touch detection system set forth in claim 10, wherein applying a software filter comprises:
determining if the potential touch point lies outside the touch area based on comparing coordinates of the potential touch point to boundaries of the touch area;
if the potential touch point lies outside the touch area, identifying the potential touch point as likely a ghost touch point.

12. The touch detection system set forth in claim 10, wherein applying a software filter comprises:
evaluating a size of the hypothetical touch corresponding to the potential touch point; and
if the size of the hypothetical touch exceeds a threshold, identifying the potential touch point as likely a ghost touch point.

13. The touch detection system set forth in claim 12, wherein the potential touch point is identified as likely a ghost touch point if the size of the hypothetical touch exceeds a threshold and the potential touch point is positioned nearest to the edge of the touch area.

14. The touch detection system set forth in claim 10, wherein applying a software filter comprises:
evaluating a measure of symmetry of the hypothetical touch corresponding to the potential touch point; and
identifying the potential touch point as likely a ghost touch point based on a threshold for symmetry or asymmetry.

15. The touch detection system set forth in claim 10, wherein applying a software filter comprises:
determining a shape of the hypothetical touch corresponding to each of the potential touch points;
identifying two hypothetical touches that are most symmetrical; and
identifying the potential touch points corresponding to the two hypothetical touches that are most symmetrical as true touch points.

16. The touch detection system set forth in claim 10, wherein the computing system is further configured to determine a hypothetical touch corresponding to each potential touch point based on the shape of a respective area containing the touch point, the area defined by the edges of two intersecting shadows.

17. A computer-readable medium tangibly embodying program code operable for causing a processor to identify a true or a ghost touch point from a plurality of potential touch points, the computer-readable medium comprising:
program code for accessing data identifying a plurality of potential touch points; and
program code for applying a software filter to determine if at least one potential touch point can be identified as likely a true touch or a ghost touch point based on at least one of:
(i) the potential touch point's location relative to a predefined touch area or (ii) a characteristic of a hypothetical touch corresponding to the potential touch point.

18. The computer-readable medium set forth in claim 17, wherein program code for applying a software filter comprises:
program code for determining if the potential touch point lies outside the predefined touch area based on the coordinates of the potential touch point; and
program code for identifying the potential touch point as likely a ghost touch point if the potential touch point lies outside the predefined touch area.

19. The computer-readable medium set forth in claim 17, wherein program code for applying a software filter comprises:
program code for determining a size of the hypothetical touch corresponding to the potential touch point; and
program code for identifying the potential touch point as likely a ghost touch point if the size of the hypothetical touch exceeds a threshold.

20. The computer-readable medium set forth in claim 17, wherein the program code for applying a software filter comprises:
program code for evaluating a shape of the hypothetical touch corresponding to the potential touch point; and
program code for identifying the potential touch point as likely a ghost touch point based on evaluating the relative symmetry or asymmetry of the shape.

21. The computer-readable medium set forth in claim 17, wherein the program code further comprises:
program code for directing an illumination system to direct light across the predefined touch area;
program code for receiving data identifying four shadows;
program code for triangulating coordinates for the four potential touch points from the intersections of the four shadows; and
program code for determining a hypothetical touch corresponding to each potential touch point based on the shape of a respective area containing the touch point, the area defined by the edges of two intersecting shadows.
